(19) United States
(12) Patent Application Publication
(10) Pub. No.: US 2026/0266540 A1
(43) Pub. Date: Sep. 10, 2026

(54) METHOD AND DEVICE FOR COUPLING REFRIGERATING AND HEAT TRANSFER EFFECTS

(71) Applicant: CRYO RUR, Wissous (FR)

(72) Inventors: Denis CLODIC, Wissous (FR); Joseph TOUBASSY, Wissous (FR)

(73) Assignee: CRYO RUR, Wissous (FR)

(21) Appl. No.: 19/168,084

(22) PCT Filed: Mar. 20, 2024
(86) PCT No.: PCT/EP2024/057470

§ 371 Date: Sep. 23, 2025

(30) Foreign Application Priority Data
Mar. 27, 2023 (FR) FR2302908

(51) Int. Cl. F25J 3/06

(52) U.S. Cl. CPC F25J 3/067; F25J 3/0695; F25J 2205/20; F25J 2220/84

(57) ABSTRACT

A process using a liquid transfer fluid whose triple point temperature is less than −125° C., such as isopentane, in order to recover cold energy of sublimating and melting substances frosted on exchanger surfaces and more particularly CO₂. The same transfer fluid circulates on two coupled circuits, one purely refrigerating, the other heat transferring, when it carries out defrosting operations, and refrigerating to transfer refrigerating power recovered during the defrosting operations.

### TECHNICAL FIELD

The invention concerns the treatment of fumes containing water vapour and carbon dioxide, and possibly a nitrogen oxide.

### STATE OF THE ART

The recovery of carbon dioxide CO₂ for reuse or geological storage has become a major goal to limit the increase in CO₂ concentrations in the atmosphere.

Many gas mixtures containing high CO₂ concentrations should be treated at their emission sources.

The main gas mixtures to be treated are:
biogases, which may contain 30 to 50% CO₂ by volume,
synthesis gases derived from the gasification of biomass, which may contain 25 to 35% CO₂ by volume,
combustion fumes from power plants (natural gas, wood, coal, fuel oil), which may contain CO₂ with volume concentrations ranging from 10 to 15%,
fumes from industrial processes for the production of glass, lime, cement and steel, which may have CO₂ volume concentrations ranging from 10 to 40%.

Note that all these gas mixtures contain water vapour as well. Industrial fumes typically contain 10-35% CO₂ and 5-15% water vapour.

Flow rates of fumes to be treated typically range from 50,000 to 1 million Nm³/h. Cryogenic CO₂ frosting processes require surface areas counted in thousands of m² for such fumes flow rates. These exchange surface areas are distributed over several dozen or even several hundred exchangers that operate according to CO₂ frosting and defrosting cycles.

In the energy balance, water condensation and then frosting represents from 10 to 25% of the energy requirements, when these fumes are cooled from 50° C. to −40° C.

CO₂ cooling and frosting from −90° C. to −120° C. represents an energy expenditure in the order of 45 to 55% of the total energy consumption, the remainder to 100% being nitrogen cooling.

Processes that frost and defrost CO₂, as described for example in document WO02/060561 (Armines, 2002), have to recover the carbon dioxide sublimation energy, to minimise their energy consumption associated with CO₂ frosting.

In the state of the art, the CO₂ sublimation energy is recovered in various processes, either in a liquid and solid mixture as described in documents WO2012/061544 (Battelle, 2012) or US2012/0103561 (Battelle, 2012), or by a refrigerant as described in document U.S. Pat. No. 6,082,133 (Cryo Fuel Systems, 2000), or under low pressure as described in document WO2016/162643 (Cryo Pur, 2016).

CO₂ frosting at a pressure below its triple point, which is 520 kPa and −56.5° C., requires energy that ranges from 550 to 595 KJ/kg, depending on the antisublimation temperature.

Antisublimation here refers to the direct transition from gas phase to solid phase. Parameters influencing the carbon dioxide capture by antisublimation are the subject of modelling attempts, see for example Tian et al. Energy Engineering 2020, 117(5), 267-277. https://DOI.org/10.32604/EE.2020.011440; Ababneh et al. Processes, Vol 10, Iss 2406, p 2406 (2022) DOI: 10.3390/pr10112406.

CO₂ sublimation and melting represents energy in the order of 200 to 220 KJ/kg.

### OBJECT OF THE INVENTION

One object of the invention is to solve the problem of the high energy efficiency management of the CO₂ frosting and defrosting cycles, but also of substances such as water H₂O or nitrogen dioxide NO₂, regardless of the flow rates, and advantageously for high flow rates.

### GENERAL DESCRIPTION OF THE INVENTION

The invention provides the recovery of cold energy by a transfer fluid playing the dual role of refrigerant and heat transfer fluid, to recover energy from very low temperatures, in the order of −150° C., up to ambient temperature.

Such fluids are hydrocarbons that are liquid at ambient temperature, such as isopentane (2-methylbutane, CAS 78-78-4) or isohexane (2-methylpentane, CAS 107-83-5), and whose triple point temperature is less than −125° C. and preferably less than −150° C. According to Tan et al., the triple point temperature of 2-methylbutane is 117 K, i.e. about −156° C. (Journal of thermal analysis. June 1994 41(6):1577-1592 DOI: 10.1007/bf 02549956). According to Douslin et al., the triple point temperature of 2-methylpentane is 119 K, i.e. about −154° C. (Douslin, D. R. ; Huffman, H. M., Low-Temperature Thermal Data on the Five Isomeric Hexanes, J. Am. Chem. Soc., 1946, 68, 1704, doi.org/10.1021/ja01213a006).

The invention provides coupling two circuits, one refrigerating and the other heat transferring and refrigerating, the two circuits using the same transfer fluid, the triple point of which is advantageously lower than −125° C., and even more advantageously lower than −150° C., such as for example isopentane, the triple point of which is at −156° C., to recover cold energy of the CO₂ sublimation and melting and cold energy of molecules such as nitrous oxide N₂O, nitrogen dioxide NO₂ and water when present in the gas mixture to be cold treated. The refrigerating fluid is cooled to the lowest temperature level. The heat transfer and refrigerating fluid recovers cold defrosting energy (and then works in heat transfer) and transmits this cold energy at a higher temperature, (and thereby works in refrigeration).

It is further provided that energy recovery is carried out by a process alternately operating on at least one pair of exchangers, one operating in frosting and the other in defrosting of CO₂. Depending on the facility sizes, there can be dozens or even several hundred pairs of exchangers operating in parallel and alternately.

It is further provided that energy recovery is also carried out by a process alternately operating on at least one pair of exchangers, one operating in frosting and the other in defrosting of water.

It is also provided that energy recovery is carried out by a process alternately operating on at least one pair of exchangers, one operating in frosting and the other in defrosting of nitrogen dioxide NO₂ or nitrous oxide N₂O.

For these purposes, it is provided, according to a first aspect, a process for treating fumes containing water vapour and carbon dioxide and optionally a nitrogen oxide, the process comprising a first step of cooling the fumes to be treated, by frosting the water and optionally the nitrogen dioxide NO₂, this first step producing cooled fumes, the process comprising a second step of cooling and dehumidifying the cooled fumes, by frosting the water contained in these cooled fumes, this second step producing dehumidified fumes, the process comprising a third step of cooling and decarbonising the dehumidified fumes, by frosting the carbon dioxide into carbon dioxide ice and optionally a nitrogen oxide contained in the dehumidified fumes, each of the three fumes treatment steps being carried out by an exchanger of a pair of exchangers, a transfer fluid circulating in each exchanger, each exchanger of a pair of exchangers being in the frosting mode for cooling the fumes while the other exchanger is in the defrosting mode for the water ice or the carbon dioxide ice formed during a cooling step carried out previously, the transfer fluid being refrigerating in the exchangers in the frosting mode, the transfer fluid being heat transferring in the exchangers in the defrosting mode, the transfer fluid recovering cold energy of sublimating and melting carbon dioxide ice obtained in the third, cooling and decarbonisation, step and transferring this cold energy for cooling the fumes in the first, treatment, step, the transfer fluid having a triple point whose temperature is less than −125° C.

Advantageously, the transfer fluid comprises isopentane or isohexane.

Advantageously, the transfer fluid circulates in a refrigerating circuit and a transfer fluid (advantageously the same transfer fluid) circulates in a heat transferring/refrigerating circuit, the heat transferring/refrigerating circuit recovering cold energy of sublimating and melting the carbon dioxide ice obtained in the third, cooling and decarbonisation, step and transferring this cold energy for cooling the fumes in the first treatment step.

In some implementations, the process comprises a step of measuring the carbon dioxide concentration in the fumes to be treated and cooled in the first treatment step; a step of comparing the carbon dioxide concentration measured with a threshold value, a flow rate of the predetermined heat transferring/refrigerating circuit providing refrigerating power to cool the fumes to a target temperature in the first cooling step for this threshold value; a step of mixing the transfer fluid of the refrigerating circuit and the transfer fluid of the refrigerating/heat transferring circuit, when the carbon dioxide concentration measured is less than the threshold value, the flow rate of the mixture obtained being substantially equal to the predetermined flow rate.

Advantageously, for the exchangers of the third step of cooling and decarbonising the fumes, the transfer fluid of the heat transferring/refrigerating circuit circulates on an exchanger alternately with the transfer fluid of the refrigerating circuit, the transfer fluid of the refrigerating circuit ensuring cooling of the fumes and frosting of the carbon dioxide in the exchanger, the transfer fluid of the heat transferring/refrigerating circuit ensuring defrosting of the carbon dioxide in the exchanger.

Advantageously, for the exchangers of the first step of cooling the fumes to be treated, the transfer fluid of the heat transferring/refrigerating circuit circulates on an exchanger alternately with the transfer fluid of the refrigerating circuit, the transfer fluid of the refrigerating circuit partially ensuring or not cooling of the fumes and frosting of the water into water ice in the exchanger, the transfer fluid of the heat transferring/refrigerating circuit partially or totally ensuring cooling of the fumes and frosting of the water, and thereby being refrigerating by transferring frigories recovered upon defrosting the carbon dioxide during the third step, the transfer fluid of the heat transferring/refrigerating circuit also being heat transferring upon defrosting the water ice in the exchanger.

Advantageously, for the exchangers of the second step of cooling and dehumidifying the fumes, the transfer fluid of the heat transferring/refrigerating circuit circulates on an exchanger alternately with the transfer fluid of the refrigerating circuit, the transfer fluid of the refrigerating circuit ensuring cooling of the fumes and frosting of the water into water ice in the exchanger, the transfer fluid of the heat transferring/refrigerating circuit ensuring defrosting of the water ice in the exchanger.

Advantageously, the same transfer fluid circulates in the refrigerating circuit and the heat transferring/refrigerating circuit.

There is provided, according to a second aspect, a device for treating fumes containing water vapour and carbon dioxide and optionally a nitrogen oxide, the device comprising a first pair of exchangers for a first step of cooling the fumes to be treated, by frosting the water, this first step producing cooled fumes, the device comprising a second pair of exchangers for a second step of cooling and dehumidifying the cooled fumes, by frosting the water and optionally the nitrogen dioxide NO₂ contained in these cooled fumes, this second step producing dehumidified fumes, the device comprising a third pair of exchangers, for a third step of cooling and decarbonising the dehumidified fumes, by frosting the carbon dioxide into carbon dioxide ice and optionally a nitrogen oxide contained in the dehumidified fumes, a transfer fluid circulating in each exchanger, each exchanger of a pair of exchangers being in the frosting mode for cooling the fumes while the other exchanger is in the defrosting mode for the water ice or the carbon dioxide ice formed during a cooling step carried out previously, the transfer fluid being refrigerating in the exchangers in the frosting mode, the transfer fluid being heat transferring in the exchangers in the defrosting mode, the transfer fluid recovering cold energy of sublimating and melting the carbon dioxide ice obtained in the third, cooling and decarbonisation, step and transferring this cold energy for cooling the fumes in the first treatment step, the transfer fluid having a triple point whose temperature is less than 125° C.

Advantageously, the device comprises a refrigerating circuit in which a transfer fluid circulates, and a heat transferring/refrigerating circuit in which a transfer fluid circulates (advantageously the same transfer fluid), the heat transferring/refrigerating circuit recovering cold energy of sublimating and melting the carbon dioxide ice obtained in the third, cooling and decarbonisation, step and transferring this cold energy for cooling the fumes in the first treatment step.

Advantageously, the device comprises means for measuring the carbon dioxide concentration in the fumes to be treated and cooled in the first pair of exchangers, in the first treatment step; means for comparing the carbon dioxide concentration measured with a threshold value, a predetermined flow rate of the heat transferring/refrigerating circuit providing refrigerating power to cool the fumes to a target temperature in the first cooling step for this threshold value; means for mixing transfer fluid of the refrigerating circuit and the transfer fluid of the refrigerating/heat transferring circuit, when the carbon dioxide concentration measured is lower than the threshold value, the flow rate of the mixture obtained being substantially equal to the predetermined flow rate.

Advantageously, the transfer fluid comprises isopentane or isohexane.

Advantageously, the same transfer fluid circulates in the refrigerating circuit and the heat transferring/refrigerating circuit.

Further objects and advantages of the invention will appear during the description of embodiments, which description will be made with reference to the appended figures wherein

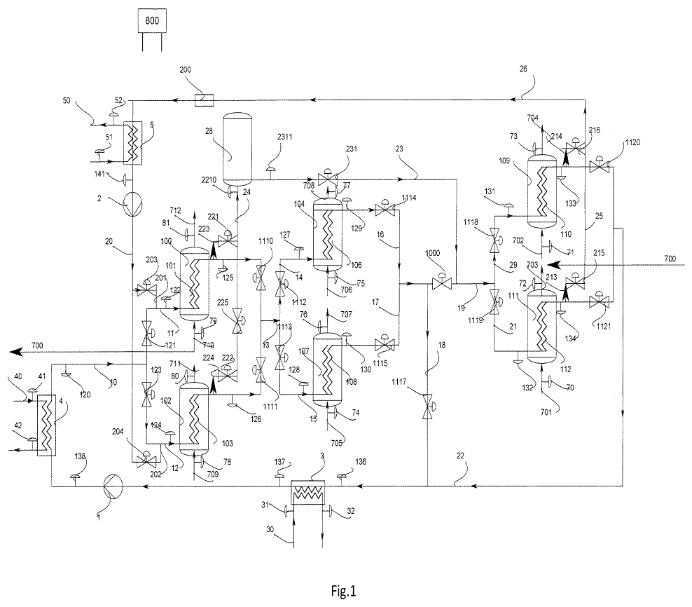

FIG. 1 is a schematic representation of a facility for cooling fumes and frosting and defrosting water vapour, and then carbon dioxide, the facility comprising a refrigerating circuit and a heat transferring/refrigerating circuit;

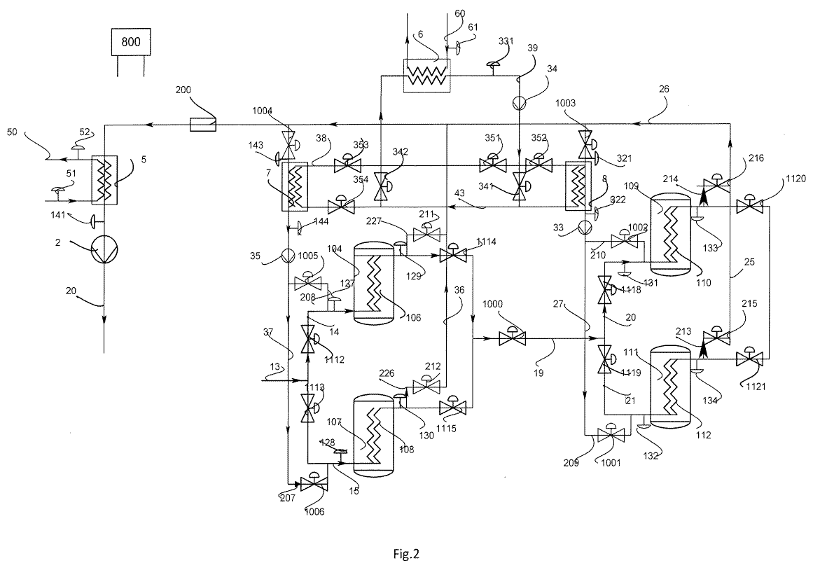

FIG. 2 is a schematic representation of the facility represented in FIG. 1, some elements of the refrigerating circuit being omitted, for the sake of simplification, FIG. 2 detailing some elements of the heat transferring/refrigerating circuit.

In the following description, the temperature values correspond to an example of decarbonisation of fumes containing 30% by mass of CO₂ and 70% of nitrogen, which corresponds to the volume concentrations of 21.5% of carbon dioxide CO₂ and therefore of 78.5% of nitrogen.

The facility represented in the figures allows, on a circuit 700, cooling of such fumes, and frosting and defrosting of water vapour, and then carbon dioxide.

In the description, the terms upstream and downstream are employed with reference to the direction of circulation of the fluids, this direction of circulation being made apparent by arrows placed on the ducts of the different circuits of the facility, the ducts being represented in the form of lines.

The facility comprises a refrigerating circuit 10 and a heat transferring/refrigerating circuit 20.

The use of the “/” sign means that the fluid circulating in the circuit 20 has a heat transferring fluid or a refrigerating fluid function, depending on the operating mode of the facility.

The circuit 700 is partially represented, so that the refrigerating circuit 10 and the heat transferring/refrigerating circuit 20 are clearly visible.

The facility represented in appended FIG. 1 comprises two exchangers 110, 112 for cooling the fumes and for frosting water.

The fumes to be cooled alternately enter through the lines 701 and 702 into an enclosure 109 or 111 containing the exchangers 110, 112 respectively.

The facility comprises two exchangers 106, 108 for further cooling of the fumes which have left either the exchanger 110 or the exchanger 112.

The fumes exiting the exchanger 110 or the exchanger 112 alternately enter through the lines 705 or 706 into an enclosure 104 or 107 containing the exchangers 106, 108 respectively.

The facility comprises two exchangers 101, 103 for cooling and decarbonising the dehumidified fumes. Decarbonisation here refers to the reduction in the greenhouse gases contained in the fumes, in particular carbon dioxide.

The fumes to be cooled and decarbonised alternately enter through the lines 709 and 710 into an enclosure 100 or 102 containing the exchangers 101, 103 respectively.

The refrigerating fluid entering the exchangers 101, 103, 106, 108, 110, 112 (hereinafter referred to as evaporators 101, 103, 106, 108, 110, 112) comes from the refrigerating circuit 10.

On the circuit 10, the entry of the refrigerating fluid in the evaporator 101 or evaporator 103 is controlled by a solenoid valve 121 disposed on an entry line 11 of the evaporator 101, and a solenoid valve 123 disposed on an entry line 12 of the evaporator 103. The exit of the refrigerant from the evaporator 101 is controlled by a solenoid valve 1110. The exit of the refrigerating fluid from the evaporator 103 is controlled by a solenoid valve 1111. The ducts carrying the exit solenoid valves 1110, 1111 of the evaporators 101, 103 join on a common branch 13.

On the circuit 10, circulation of the refrigerating fluid in the evaporator 106 or in the evaporator 108, from the common branch 13, is controlled by a solenoid valve 1112 disposed on an entry line 14 of the evaporator 106, and a solenoid valve 1113 disposed on an entry line 15 in the evaporator 108. The exit of the refrigerating fluid from the evaporator 106 is controlled by a solenoid valve 1114 disposed on an exit branch 16 of the evaporator 106. The exit of the refrigerating fluid from the evaporator 108 is controlled by a solenoid valve 1115 disposed on an exit branch 17 of the evaporator 108. The exit branches 16 and 17 of the evaporators 106, 108 join on a common branch 19.

On the circuit 10, circulation of the refrigerating fluid in the evaporator 110 or in the evaporator 112, from the common branch 19, is controlled by two solenoid valves, namely a solenoid valve 1118 on an entry branch 29 into the evaporator 110, and a solenoid valve 1119 on an entry branch 21 into the evaporator 112. The exit of the refrigerating fluid from the evaporator 110 is controlled by a solenoid valve 1120. The exit of the refrigerating fluid from the evaporator 112 is controlled by a solenoid valve 1121. The ducts carrying the solenoid valves 1120, 1121 join in a common branch 22.

The refrigerating circuit 10 includes, downstream of the common branch 22, a counter-current refrigerating exchanger 30, and a pump 1 circulating the refrigerating fluid.

The refrigerating circuit 10 includes, downstream of the refrigerating exchanger 30, a counter-current refrigerating exchanger 40.

Two probes 136, 137 allow measuring the temperature of the refrigerating fluid at the entry and exit of the refrigerating exchanger 30.

Two probes 138, 120 allow measuring the temperature of the refrigerating fluid at the entry and exit of the refrigerating exchanger 40.

The facility comprises a heat transferring/refrigerating circuit 20.

The circuit 20 comprises a pump 2 circulating a transfer fluid.

The circuit 20 conveys the transfer fluid to the entry of the evaporator 103, through a connection to the refrigerating circuit 10, on the entry line 12 of the evaporator 103.

The entry of the transfer fluid in the evaporator 103 is controlled by a solenoid valve 204 placed on a branch 202 of the circuit 20, upstream of a connection between the circuits 10, 20.

The circuit 20 conveys the transfer fluid to the entry of the evaporator 101, through a connection to the refrigerating circuit 10, on the entry line 11 of the evaporator 101.

The entry of the transfer fluid in the evaporator 101 is controlled by a solenoid valve 203, placed on a branch 201 of the circuit 20, upstream of a connection between the circuits 10,20.

Circulation of the transfer fluid in the evaporators 101, 103 allows them to be defrosted, the transfer fluid is thereby heat transferring, circulating at the exit of the evaporators 101, 103 by exit branches 223 and 224, a solenoid valve 221 and 222 being placed on each of these two exit branches 223, 224.

The exit branches 223, 224 of the evaporators 101, 103 are connected to a common line 24. A solenoid valve 225 is placed on this common line 24, between the junction point with the exit branch 223 and the junction point with the exit branch 224.

When the transfer fluid exits the evaporator 101, the solenoid valves 1110 and 225 are closed, and the solenoid valve 221 is open, the transfer fluid exiting the evaporator 101 through the branch 223 and being sent to a reservoir 28 through the common branch 24.

When the transfer fluid exits the evaporator 103, the solenoid valves 221 and 1111 are closed, and the solenoid valves 222 and 225 are open, the transfer fluid exiting the evaporator 103 via the branch 224 and being sent to the reservoir 28 via the common branch 24.

The reservoir 28 is connected by a line 23 to the common branch 19 of the circuit 10.

A solenoid valve 231 is placed on line 23.

The circuit 20 thus conveys the transfer fluid up to the entry of the evaporator 110, or of the evaporator 112.

The entry of the transfer fluid in the evaporator 110 is controlled by the solenoid valve 1118 placed on the branch 29 of the circuit 10, the transfer fluid exiting the reservoir 28 through the branch 23, the valve 231 being open.

The entry of the transfer fluid coming from the branch 23 in the evaporator 112 is controlled by the solenoid valve 1119 placed on the branch 21 of the circuit 10, the transfer fluid exiting the reservoir 28 through the branch 23, the valve 231 being open. Circulation of the transfer fluid in the evaporators 110, 112 allows them to be frosted, the transfer fluid thereby acting as a refrigerating fluid, the transfer fluid circulating at the exit of the evaporators 110, 112 on a common line 25.

A solenoid valve 215 is disposed on an exit branch 213 of the evaporator 112. A solenoid valve 216 is disposed on an exit branch 214 of the evaporator 110. The two exit branches 213, 214 of the evaporators 110, 112 are connected to the common line 25.

When the transfer fluid exits the evaporator 110, the solenoid valve 1120 of the circuit 10 is closed, and the solenoid valve 216 placed on the branch 214 of the circuit 20 is open.

When the transfer fluid exits the evaporator 112, the solenoid valve 1121 of the circuit 10 is closed, and the solenoid valve 215 placed on the branch 213 of the circuit 20 is open.

The heat transferring/refrigerating circuit 20 comprises a refrigerating system 50, and a flow meter 200.

The fumes entry temperatures of each exchanger 101, 103, 106, 108, 110, 112 are measured by probes 78, 79, 74, 75, 70, 71 carried by lines or pipes 709, 710, 705, 706, 701, 702.

The fumes exit temperatures of each exchanger 101, 103, 106, 108, 110, 112 are measured by probes 80, 81, 76, 77, 72, 73 carried by pipes 711, 712, 707, 708, 703, 704.

The transfer fluid or refrigerating fluid entry temperatures into the enclosures 100, 102, 104, 107, 109, 111 of the exchangers 101, 103, 106, 108, 110, 112 are measured by probes 122 (on branch 11), 124 (on branch 12), 127 (on branch 14), 128 (on branch 15), 131 (on branch 29), 132 (on branch 21).

The temperatures of the transfer fluid or refrigerating fluid exiting the enclosures 100, 102, 104, 107, 109, 111 of the exchangers 101, 103, 106, 108, 110, 112 are measured by probes 125, 126, 129 (on branch 16), 130 (on branch 17), 133, 134.

A regulation solenoid valve 1000 is disposed on the common branch 19, between the junction of the common branch 19 with the line 23 and the junction of the common branch 19 with a branch 18 linking to the common branch 22.

A solenoid valve 1117 is placed on the linking branch 18.

The operation of the refrigerating circuit 10 on the one hand and the heat transferring/refrigerating circuit 20 on the other hand, will be described in detail, with reference to FIG. 1, showing circulations of a same transfer fluid in these two circuits 10,20.

In a first operating mode of the facility, the exchanger 101 operates in CO₂ frosting mode and the exchanger 103 in defrosting mode.

CO₂ frosting is related to the circulation of the refrigerating fluid of the circuit 10 in the exchanger 101, and CO₂ defrosting is related to the circulation in the exchanger 103 of the fluid of the refrigerating/heat transferring circuit 20, this fluid acting in heat transfer. This operating mode allows recovery of cold energy of CO₂ defrosting by the heat transferring/refrigerating circuit 20 coupled to the refrigerating circuit 10.

In a second operating mode (subsequently set forth with reference to FIG. 2), defrosting of water ice by the heat transferring/refrigerating circuit 20 will be described. The fumes are cooled by the exchanger 110 or the exchanger 112, according to the water frosting and defrosting cycles.

In cooling mode, the fumes to be treated enter the enclosure 111 which contains the cooling exchanger 112 through the pipe 701, and exit the enclosure 111, through the pipe 703, or the fumes to be treated enter through the pipe 702 into the enclosure 109 which contains the cooling exchanger 110 and exit the enclosure 109 through the pipe 704.

The fumes to be treated advantageously enter the enclosure 111 or the enclosure 109 at a temperature of 2° C., and advantageously exit the enclosure 111 or the enclosure 109 at a temperature of −52° C. Thus, as indicated previously, the temperature values mentioned here correspond to an example of decarbonisation of fumes containing 30% by mass of CO₂ and 70% of nitrogen, which corresponds to the volume concentrations of 21.5% of carbon dioxide CO₂ and therefore of 78.5% of nitrogen.

Then, the fumes exiting the enclosure 109 or 111 are cooled, advantageously from −52° C. to −90° C., by the exchanger 106 contained in the enclosure 104 or by the exchanger 108 contained in the enclosure 107, according to the water frosting and defrosting cycles.

Finally, the fumes, preferably very dehumidified, advantageously around 0.1 ppm(v), exiting the exchanger 106 or the exchanger 108 are cooled, advantageously from −90° C. to −120° C., by the exchanger 101 contained in the enclosure 100 or by the exchanger 103, contained in the enclosure 102 operating in CO₂ frosting mode.

The fumes enter the exchanger 103 through the pipe 709, advantageously at a temperature of −90° C., and exit the exchanger 103, advantageously at a temperature of −120° C., through the pipe 711, or the fumes enter the exchanger 101 through the pipe 710 and exit the exchanger 101 through the pipe 712.

The progressive cooling of the fumes, advantageously up to a temperature of −120° C., causes them to be dehumidified, and their decarbonisation is carried out on the circuit 700 by the different branches 701-712.

The operation of a facility as represented in FIG. 1, coupling a refrigerating circuit 10 and a heat transferring/refrigerating circuit 20, the two circuits 10, 20 advantageously operating with the same transfer fluid, in particular advantageously isopentane, is described below.

The refrigerating circuit 10 is circulated by the pump 1.

The refrigerant, the temperature of which is measured by the probe 138, downstream of the pump 1, then enters an evaporator 4 of the refrigerating circuit 40, advantageously at a temperature of −95° C., and exits the evaporator 4 at a temperature advantageously of −125° C., this exit temperature being measured by the probe 120.

The refrigerating circuit 40 cools the refrigerant by counter-current with a start of evaporation, advantageously at −128° C., this temperature being measured by a probe 41, the refrigerant exiting the evaporator 4 advantageously at a temperature of −98° C., this exit temperature being measured by a probe 42.

According to the CO₂ frosting cycle, the refrigerant enters either the exchanger 101, contained in the enclosure 100, or the exchanger 103, contained in the enclosure 102. When the refrigerant circulates in the exchanger 103, the solenoid valves 123 and 1111 placed at the entry and exit of the exchanger 103 are open, and the solenoid valves 121, 1110 and 221 placed at the entry and exit of the exchanger 101 are closed, the refrigerant entering the evaporator 103 by the branch 12, advantageously at −125° C., this entry temperature being measured by the probe 124.

The refrigerant cools the fumes and frosts the CO₂ in the exchanger 103.

The typical duration of the frosting cycle is advantageously one hour.

The refrigerant exits the evaporator 103, advantageously at a temperature of −95° C., this exit temperature being measured by the probe 126, and joins the common branch 13, via the solenoid valve 1111.

The refrigerant then enters the exchanger 108, advantageously at a temperature of −95° C., this entry temperature being measured by the probe 128, the exchanger 108 being integrated into the enclosure 107 where the fumes are cooled, advantageously up to a temperature of −90° C.

The duration of the water vapour frosting cycle is advantageously in the order of 48 hours, given the low moisture content when the fumes enter the pipe 705, a value of 30 ppm corresponding to the saturating humidity at −52° C.

The refrigerant exits the exchanger 108, advantageously at a temperature of-57° C., this exit temperature being measured by the probe 130.

The refrigerant joins, via the branch 17, the common branch 19, the valve 1115 being open. The regulation valve 1000 is closed, the solenoid valve 1117 placed on the linking branch 18 is open.

Advantageously, the refrigerant does not enter the common branch 19 when the CO₂ volume concentration in the fumes to be treated is greater than or equal to 21.5%, a value which allows the heat transferring/refrigerating loop 20 to provide the entire refrigerating power to cool the fumes down to −52° C. in the exchangers 110, 112.

Advantageously, the regulation valve 1000 opens for CO₂ concentrations below 21.5% in the fumes to be treated, to authorise mixing in the common branch 19 of the refrigerant coming from the branch 17 with the heat transfer fluid/refrigerant coming from the branch 23, to ensure temperature control, advantageously at a value in the range of −54° C., if the heat flow at −54° C. of the heat transfer fluid/refrigerant in the branch 23 is insufficient.

When the heat flow of the heat transfer fluid/refrigerant is sufficient, as indicated, the refrigerant does not pass into the common branch 19 (the regulation valve 1000 being closed). The refrigerant then passes through the linking branch 18, is sucked by the pump 1 and cooled in the refrigerating exchanger 30, advantageously from an entry temperature of −54° C., this temperature being measured by the probe 136, up to an exit temperature of −95° C., this exit temperature being measured by the probe 137.

The refrigerating exchanger 30 is counter-current, with an entry temperature, advantageously at−98° C., measured by a probe 31 and an exit temperature, advantageously at −59° C., measured by a probe 32.

The pump 2 of the heat transferring/refrigerating circuit 20 advantageously circulates the same transfer fluid, advantageously isopentane, the two circuits 10, 20 alternately circulating in the same exchangers 101, 103 at each CO₂ frosting and defrosting cycle.

If the thermal flow of the heat transfer fluid/refrigerant has to be supplemented, the regulation solenoid valve 1120 (when the exchanger 110 is in water frosting mode) is open or the regulation solenoid valve 1121 (when the exchanger 112 is in water frosting mode) is open, to allow the same flow rate that the valve 1000 has sent to either of these exchangers 110, 112 to return to the branch 19 of the circuit 10 to ensure the temperature of −54° C. measured by the probes 133 or 134.

By difference, the flow rate of the refrigerant/heat transfer fluid from circuit 20 returns to the pump 2 via the branch 26.

The heat transferring/refrigerating circuit 20 is so named because it provides heat to defrost CO₂ of the exchangers 101 or 103 and produces cold on the exchangers 110 or 112. This gain makes it possible for the return temperature of the refrigerant to the branch 22 to be as low as possible, advantageously at −54° C., when the circuit 20 provides the entire refrigerating power of the exchangers 110 or 112, this is the indirect gain.

The circuit 20 is refrigerating for cooling the fumes and frosting the water in the exchangers 110, 112, this cold energy recovery associated with CO₂ defrosting constitutes the direct gain.

The following description is made by following circulation of the transfer fluid along circuit 20, when defrosting CO₂.

At the exit of an exchanger 5 of the refrigerating circuit 50, the temperature measured by a probe 141 is advantageously −5° C., a temperature allowing CO₂ defrosting.

The solenoid valve 203 of the branch 201 is open, as well as the solenoid valve 221 of the branch 223, the solenoid valve 204 of the branch 202 is closed, as well as the solenoid valve 225 of the common branch 24, since the exchanger 103 is in frosting mode. The transfer fluid advantageously enters the exchanger 101 at −5° C., in defrosting mode, a temperature measured by the probe 122, at the entry of the exchanger 101, and the solenoid valves 121, 1110 and 204 are closed.

The exchanger 101, at the beginning of defrosting, is advantageously at an average temperature of −110° C., and the enclosure 100 was put under vacuum at the beginning of the CO₂ defrosting cycle.

The transfer fluid cools by heating the exchanger, CO₂ sublimates, the pressure in the enclosure advantageously rises gradually to 520 kPa, which is the pressure of the triple point of CO₂, then CO₂ transitions from the solid phase to the gas phase at −56° C.

The transfer fluid exits through the branch 223, via the solenoid valve 221, and joins the reservoir 28 via the common line 24.

Given that CO₂ sublimation from −120° C. to −56° C. represents one third of the melting energy, the average temperature of the transfer fluid in the reservoir 28 is in the order of −62° C., measured by two probes 2210 and 2311, these two probes 2210, 2311 being respectively placed at the entry, at the exit of the reservoir 28.

Storage of the transfer fluid in the reservoir 28 ensures stable flow rate of the heat transfer/refrigerating fluid for frosting operations of the exchangers 110 or 112.

With the solenoid valve 231 open, the transfer fluid exiting the reservoir 28 via the branch 23 then becomes a refrigerant.

This fluid joins the branch 19 and will cool the exchanger 110 because the solenoid valve 1118 of the branch 29 is open and the solenoid valve 1119 of the branch 21 is closed.

The exchanger 110 is advantageously a fin tube exchanger, where the fumes circulating on the fins are cooled by 2° C., a temperature measured by the probe 71, up to advantageously −52° C., a temperature measured by the probe 73.

The refrigerant, circulating in the tubes, advantageously enters at −64° C., a temperature measured by the probe 131, and advantageously exits at −5° C., a temperature measured by the probe 133, and joins the branch 25 via the regulation valve 216 which is open, the regulation valve 215 being closed.

The heat transfer fluid joins the pump 2 via the line 26 and in this case of operation, the exchanger 5 does not need to cool the heat transferring/refrigerating fluid.

The refrigerating/heat transferring circuit 20 recovers cold energy from CO₂ defrosting and transfers this energy for fumes cooling from 2° C. to −52° C.

Advantageously, as soon as the CO₂ volume concentration is equal to or greater than 21.5% in the mixture of gases to be treated, the heat flow of the heat transfer fluid/refrigerant from cold energy recovered from CO₂ defrosting is sufficient to ensure all the cooling requirement.

To give another example, if the CO₂ volume concentration is 14% in a mixture of gases to be treated, the heat transferring/refrigerating circuit 20 provides 60% of the cooling requirement from 2° C. to −54° C.; the complementary 40% are provided by the refrigerating circuit 10.

In this case, the regulation valve 1000 is opened by a control command system 800, so that the temperature measured by the probes 133 or 134 is controlled to −5° C.

The flow rate of the pump 1 is regulated, so as to ensure cooling requirements of the exchangers 101 or 102 and 106 or 108, in frosting mode.

The energy savings are significant, since the refrigerating power related to CO₂ defrosting is recovered by the heat transferring/refrigerating circuit 20 at the place of cooling the gas mixture in the exchangers 110 or 112.

The operation of the refrigerating/heat transferring circuit 20 for, on the one hand, defrosting the exchangers 110, 112 for cooling the fumes and for frosting water of the exchangers 106, 108 on the other hand will be described based on FIG. 2.

In FIG. 2, elements of the circuits 10, 20 in connection with the exchangers 101, 103 are not represented, for the sake of simplification.

In this FIG. 2, the circuit 20 represented in FIG. 1 is supplemented by three branches 27, 36 and 37.

The branch 27 of the circuit 20 comprises a branch 209 for connecting to the branch 21 of the circuit 10. A solenoid valve 1001 is disposed on the connection branch 209.

The branch 27 of the circuit 20 comprises a branch 210 for connecting to the branch 29 of the circuit 10. A solenoid valve 1002 is disposed on the connection branch 210.

Upstream of the connection with the branch 210, the branch 27 of the circuit 20 is connected to the branch 26 and successively comprises a regulation solenoid valve 1003, an exchanger 8, and a pump 33.

Two probes 321, 322 allow measuring temperature of the fluid at the entry and exit of the exchanger 8.

The pump 33 of branch 27 takes part of the return flow rate of the line 26, this flow rate is regulated by the regulation solenoid valve 1003, the refrigerant/heat transfer fluid is heated in the exchanger 8, advantageously up to 15° C., to alternately defrost the exchangers 110, 112.

The heat transfer fluid flow rate is controlled by the solenoid valve 1002 on the branch 210 or by the solenoid valve 1001 on the branch 209 at the entry of the exchangers 110, 112, and is controlled at the exit of the exchangers 110, 112 by the valve 216 on the branch 214 or the valve 215 on the branch 213.

The branch 37 of the circuit 20 comprises a branch 207 for connecting to the branch 15 of the circuit 10. A solenoid valve 1006 is disposed on this connection branch 207.

The branch 37 of the circuit 20 comprises a branch 208 for connecting to the branch 14 of the circuit 10. A solenoid valve 1005 is disposed on this connection branch 208.

Upstream of the connection with the branch 208, the branch 37 of the circuit 20 is connected to the branch 26 and successively comprises a regulation solenoid valve 1004, an exchanger 7, and a pump 35.

Two probes 143, 144 allow measuring temperature of the fluid at the entry and exit of the exchanger 7.

The branch 36 of the circuit 20 comprises a branch 226 for connecting to the circuit 10, at the exit of the exchanger 108. A solenoid valve 212 is disposed on this branch 226.

The branch 36 of the circuit 20 comprises a branch 227 for connecting to the circuit 10, at the exit of the exchanger 106. A solenoid valve 211 is disposed on this branch 227.

Upstream of the connection with the branch 227, the branch 36 of the circuit 20 is connected to the branch 26.

The pump 35 of the branch 37 takes part of the return flow rate of the line 26, this flow rate is regulated by the regulation solenoid valve 1004, the refrigerant/heat transfer fluid is heated in the exchanger 7, advantageously up to 15° C., to alternately defrost the exchangers 106, 108.

The heat transfer fluid flow rate is controlled by the solenoid valve 1005 on the branch 208 or by the solenoid valve 1006 on the branch 207 at the entry of the exchangers 106, 108 and is controlled at the exit of the exchangers 106, 108 by the valve 211 on the branch 227 and the valve 212 on the branch 226.

The branch 36 is the return branch of the heat transfer fluid to the branch 26. This branch 36 is supplied by the branch 227 when the solenoid valve 211 is open upon defrosting the exchanger 106, or by the branch 226 when the solenoid valve 212 is open upon defrosting the exchanger 108.

The exchangers 7 and 8 are heated by a circuit 60, advantageously coming from an air cooler.

An exchanger 6 takes heat from the circuit 60 on a circuit 39 where a heat transfer fluid/refrigerant is circulated by a pump 34.

The exit of the exchanger 7 is connected by a branch 38 to the entry of the exchanger 8. Three solenoid valves 351, 352, 353 are disposed on the branch 38.

The exit of the exchanger 8 is connected by a branch 43 to the entry of the exchanger 7. A solenoid valve 354 is disposed on the branch 43.

The circuit 60 is connected to the line 43 by a first branch, on which the pump 34 and a solenoid valve 341 are placed. The circuit 60 is connected to the line 43 by a second branch, on which a solenoid valve 342 is placed.

The set of valves 341, 342, 351, 352, 353, 354 makes it possible to alternately supply the exchanger 7 or the exchanger 8.

The exchanger 112 is in defrosting mode and the exchanger 110 is in defrosting mode, as described previously.

The total flow rate of the heat transferring/refrigerating fluid should be doubled, since the circuit of the branch 21 requires this additional flow rate by running the pump 33 of the branch 27 for defrosting the exchanger 112.

The exchanger 112 in defrosting mode is advantageously initially at an average temperature of −27° C. and the heat transfer fluid will gradually heat it and melt the water ice deposited on the fins of this exchanger.

Upon initialising the defrosting cycle of the exchanger 112, triggered by exceeding the head loss threshold on the circuit of the fumes measured by a differential pressure sensor (not represented), the control command system 800 opens the regulation valve 1003 on the branch 27, and opens the valve 1001 located on the branch 209, as well as the solenoid valve 215 located on the branch 213, the valve 1002 being closed.

The control command system 800 increases the flow rate of the pump 2 by a factor 2, which is checked by the flow meter 200.

The branches 209 and 210 are then supplied with a similar flow rate, one refrigerating for the branch 210, the other heat transferring for the branch 209.

A circuit 60 operating on an air cooler will provide heat necessary for defrosting, by providing the flow rate required at 20° C., a temperature measured by a temperature probe 61, and thus heat the heat transfer fluid, advantageously isopentane, from a variable temperature, advantageously of −30° C., up to a temperature advantageously of +15° C., measured by a probe 331.

The pump 34 circulates an adapted heat transfer fluid, for example potassium acetate, at 20° C., on the exchanger 8, the two solenoid valves 352, 342 being open, the four solenoid valves 341, 351, 353 and 354 being closed.

The pump 33 of the branch 27 is run to suck the heat transfer fluid flow rate, also regulated by the regulation valve 1003 adjusted so as to pass half of the return flow rate onto the exchanger 8.

Return to the branch 25 takes place via the solenoid valve 215 of the branch 213.

In the defrosting mode of an exchanger 110, 112, the flow rate measured by the flow meter 200 of the branch 26 is therefore twice the flow rate without defrosting of these exchangers.

The cooling flow rate of the refrigerating circuit 50 is itself increased, to provide the refrigerating power at −10° C. measured by a temperature probe 51, and advantageously exits at +3° C., a temperature measured by a probe 52, this probe serving as an indicator to the control command system 800 to regulate the flow rate of the refrigerating system 50.

The defrosting time of the exchangers 110 or 112 is advantageously short, in the order of half an hour, whereas the defrosting time is in the order of 4 hours.

When the temperature of 15° C. is reached, indicated by the probe 134, the control command system 800 stops the pump 33, closes the regulation valves 1001 and 1003, closes the solenoid valve 215 and the flow rate of the pump 2 is reduced by a factor 2.

Defrosting of the exchangers 106 or 108 is carried out according to the same principle, but defrosting advantageously takes place once every 48h and the control command system 800 gives priority to defrosting of the exchangers 110 or 112, because the exchangers 106 and 108 can wait, to avoid having two exchangers in concomitant defrosting on the branch 26.

Advantageously, the exchanger 106 is in the frosting mode, the exchanger 108 is in the defrosting mode, its initial average temperature is about −70° C.

The heat transfer fluid, preferably isopentane, will heat this exchanger and melt the water ice deposited on the fins of this exchanger.

Upon initialisation of the defrosting cycle of the exchanger 108, triggered by exceeding the head loss threshold on the circuit of the fumes, measured by a differential pressure sensor (not represented), the control command system 800 opens the regulation valve 1004 and the valve 1006 on the branch 207 as well as the solenoid valve 212 located on the branch 226, and increases the flow rate of the pump 2 by a factor 2.

The circuit 60 will provide heat necessary for defrosting, by providing the flow rate necessary at 20° C., measured by the temperature probe 61, and thus heat the heat transfer fluid, advantageously isopentane, in the exchanger 7 advantageously from a temperature of −60° C. to a temperature of +15° C., measured by the probe 144.

The pump 34 circulates the heat transfer fluid, advantageously potassium acetate, at 20° C. on the exchanger 7, the solenoid valves 351, 352 and 342 are closed and the solenoid valves 341, 353 and 354 are open.

The pump 35 of the branch 37 is run to suck the heat transfer fluid flow rate, regulated by the regulation valve 1004 adjusted so as to pass half of the return flow rate from the branch 26 onto the exchanger 7.

Return to the branch 36, which joins the branch 26, takes place via the solenoid valve 212 of the branch 226, with solenoid valves 1115 and 211 closed.

The cooling flow rate of the refrigerating circuit 50 is increased, to provide the refrigerating power, advantageously at −10° C., a temperature measured by the temperature probe 51, and advantageously exits at the warmest at +3° C., a temperature measured by the probe 52, this probe serving as an indicator to the control command system 800 to regulate flow rate of the refrigerating system 50.

The defrosting time is advantageously clearly shorter, in the order of half an hour, while the defrosting time in the order of 48 hours, and therefore when the temperature of 15° C. is reached on the probe 130, the control command system 800 stops the pump 35, closes the regulation valves 1004 and 1006, closes the solenoid valve 212 and the flow rate of the pump 2 is reduced by a factor 2.

The pump 34 is also stopped.

The return branch of the circuit 20 transfers refrigerating power due to the water defrosting operations on the exchangers 106 and 108 on the one hand and 110 and 112 on the other hand to the heat transferring/refrigerating circuit, this refrigerating power contributing to cooling of the gas mixture or that of the refrigerating systems, which shows how the cold of the defrosting operations of the exchangers 106, 108, 110, 112 is recovered by the refrigerating/heat transferring circuit.

1. A process for treating fumes containing water vapour and carbon dioxide and optionally a nitrogen oxide, the process comprising a first step of cooling the fumes to be treated, by frosting the water and optionally the nitrogen dioxide NO₂, this first step producing cooled fumes, the process comprising a second step of cooling and dehumidifying the cooled fumes, by frosting the water contained in these cooled fumes, this second step producing dehumidified fumes, the process comprising a third step of cooling and decarbonising the dehumidified fumes, by frosting the carbon dioxide into carbon dioxide ice and optionally a nitrogen oxide contained in the dehumidified fumes, each of the three steps of treating the fumes being carried out by an exchanger of a pair of exchangers, a transfer fluid circulating in each exchanger, each exchanger of a pair of exchangers being in the frosting mode for cooling the fumes while the other exchanger is in the defrosting mode for the water ice or the carbon dioxide ice formed during a cooling step carried out previously, the transfer fluid being refrigerating in the exchangers in the frosting mode, the transfer fluid being heat transferring in the exchangers in the defrosting mode, the transfer fluid recovering cold energy of sublimating and melting the carbon dioxide ice obtained in the third, cooling and decarbonisation, step and transferring this cold energy for cooling the fumes in the first treatment step, the transfer fluid having a triple point whose temperature is less than −125° C.

2. The process according to claim 1, wherein the transfer fluid comprises isopentane or isohexane.

3. The process according to claim 1, wherein a transfer fluid circulates in a refrigerating circuit and a transfer fluid circulates in a heat transferring/refrigerating circuit, the heat transferring/refrigerating circuit recovering cold energy of sublimating and melting the carbon dioxide ice obtained in the third, cooling and decarbonisation, step and transferring this cold energy for cooling the fumes in the first treatment step.

4. The process according to claim 3, comprising a step of measuring the carbon dioxide concentration in the fumes to be treated and cooled in the first treatment step; a step of comparing the carbon dioxide concentration measured with a threshold value, a predetermined flow rate of the heat transferring/refrigerating circuit providing refrigerating power to cool the fumes to a target temperature in the first cooling step for this threshold value; a step of mixing the transfer fluid of the refrigerating circuit and the transfer fluid of the refrigerating/heat transferring circuit, when the carbon dioxide concentration measured is less than the threshold value, the flow rate of the mixture obtained being substantially equal to the predetermined flow rate.

5. The process according to claim 3, wherein, for the exchangers of the third step of cooling and decarbonising the fumes, the transfer fluid of the heat transferring/refrigerating circuit circulates on an exchanger alternately with the transfer fluid of the refrigerating circuit, the transfer fluid of the refrigerating circuit ensuring cooling of the fumes and frosting of the carbon dioxide in the exchanger, the transfer fluid of the heat transferring/refrigerating circuit ensuring defrosting of the carbon dioxide in the exchanger.

6. The process according to claim 3, wherein, for the exchangers of the first step of cooling the fumes to be treated, the transfer fluid of the heat transferring/refrigerating circuit circulates on an exchanger alternately with the transfer fluid of the refrigerating circuit, the transfer fluid of the refrigerating circuit partially ensuring or not cooling of the fumes and frosting of the water into water ice in the exchanger, the transfer fluid of the heat transferring/refrigerating circuit partially or totally ensuring cooling of the fumes and frosting of the water, and thereby being refrigerating by transferring frigories recovered upon defrosting the carbon dioxide during the third step, the transfer fluid of the heat transferring/refrigerating circuit also being heat transferring upon defrosting the water ice in the exchanger.

7. The process according to claim 3, wherein, for the exchangers of the second step of cooling and dehumidifying the fumes, the transfer fluid of the heat transferring/refrigerating circuit circulates on an exchanger alternately with the transfer fluid of the refrigerating circuit, the transfer fluid of the refrigerating circuit ensuring cooling of the fumes and frosting of the water into water ice in the exchanger, the transfer fluid of the refrigerating/heat transferring circuit ensuring defrosting of the water ice in the exchanger.

8. The process according to claim 3, wherein the same transfer fluid circulates in the refrigerating circuit and the heat transferring/refrigerating circuit.

9. A device for treating fumes containing water vapour and carbon dioxide and optionally a nitrogen oxide, the device comprising a first pair of exchangers (110, 112) for a first step of cooling the fumes to be treated, by frosting the water, this first step producing cooled fumes, the device comprising a second pair of exchangers (106, 108) for a second step of cooling and dehumidifying the cooled fumes, by frosting the water contained in these cooled fumes, this second step producing dehumidified fumes, the device comprising a third pair of exchangers (101, 103), for a third step of cooling and decarbonising the dehumidified fumes, by frosting the carbon dioxide into carbon dioxide ice and optionally a nitrogen oxide contained in the dehumidified fumes, a transfer fluid circulating in each exchanger (110, 112, 106, 108, 101, 103), each exchanger of a pair of exchangers being in the frosting mode for cooling the fumes while the other exchanger is in the defrosting mode of the water ice or the carbon dioxide ice formed during a cooling step carried out previously, the transfer fluid being refrigerating in the exchangers in the frosting mode, the transfer fluid being heat transferring in the exchangers in the defrosting mode, the transfer fluid recovering cold energy of sublimating and melting the carbon dioxide ice obtained in the third, cooling and decarbonisation, step and transferring this cold energy for cooling the fumes in the first treatment step, the transfer fluid having a triple point whose temperature is less than −125° C.

10. The device according to claim 9, comprising a refrigerating circuit (10) in which a transfer fluid circulates, and a heat transferring/refrigerating circuit (20) in which a transfer fluid circulates, the heat transferring/refrigerating circuit (20) recovering cold energy of sublimating and melting the carbon dioxide ice obtained in the third, cooling and decarbonisation, step and transferring this cold energy for cooling the fumes in the first treatment step.

11. The device according to claim 9, comprising means for measuring the carbon dioxide concentration in the fumes to be treated and cooled in the first pair of exchangers (110, 112), in the first treatment step; means for comparing the carbon dioxide concentration measured with a threshold value, a predetermined flow rate of the heat transferring/refrigerating circuit providing refrigerating power to cool the fumes to a target temperature in the first cooling step for this threshold value; means for mixing the transfer fluid of the refrigerating circuit (10) and the transfer fluid of the refrigerating/heat transferring circuit (20), when the carbon dioxide concentration measured is less than the threshold value, the flow rate of the mixture obtained being substantially equal to the predetermined flow rate.

12. The device according to claim 9, wherein the transfer fluid comprises isopentane or isohexane.

13. The device according to claim 10, wherein the same transfer fluid circulates in the refrigerating circuit (10) and the heat transferring/refrigerating circuit (20).
